(19) United States
(12) Patent Application Publication
(10) Pub. No.: US 2007/0092296 A1
(43) Pub. Date: Apr. 26, 2007

(54) Image forming method and image forming device

(76) Inventor: Masahito Ishino, Osaka (JP)

Correspondence Address: GLOBAL IP COUNSELORS, LLP, 1233 20TH STREET, NW, SUITE 700, WASHINGTON, DC, 20036-2680, US

(21) Appl. No.: 11/258,223

(22) Filed: Oct. 26, 2005

(51) Int. Cl. G03G 15/00; G03G 15/02

(52) U.S. Cl. 399/159; 399/175

(57) ABSTRACT

In electrophotographic image formation, a contact charging member, to which a square AC superimposed voltage is applied, is contacted with a positive-charged organic photosensitive member comprising a single photoconductive layer comprising charge generating material, hole transporting material, electron transporting material, and organic binders, so as to contact charge the positive-charged organic photosensitive member.

### FIELD OF THE INVENTION

The present invention relates to an electrophotographic image forming method and an image forming device using this method.

### BACKGROUND INFORMATION

In electrophotographic image forming devices such as copiers, facsimile machines, printers, and the like, a photosensitive member is uniformly provided with a primary charge and undergoes image exposure by way of irradiation based on predetermined image information, so as to form an electrostatic latent image; this electrostatic latent image is developed so as to form a toner image on the surface of the photosensitive member. The toner image formed on the surface of the photosensitive member in this manner is transferred to transfer paper; the transfer paper onto which the transfer has been made is introduced to a fixing device, the toner image is fixed to the surface of the transfer paper with heat and pressure.

Meanwhile, after the transfer is complete, the toner remaining on the surface of the photosensitive member is cleaned off, then charge removal is performed as necessary, whereby one cycle of the image forming process is completed.

Conventionally, the primary charge in electrophotographic systems was generally provided by corona discharge with a scorotron charger, but ozone and NOx which have negative effects on the human body are generated by corona discharge. Thus a contact charging system was proposed which uses brush charging or the like as means for making the process ozone-free.

For example, in a brush charging system, conductive fibers are produced by kneading conductive materials (mainly carbon) into synthetics such as nylon, rayon, or the like, and bundling these together to form brushes; the photosensitive member is charged by contacting these brushes with the surface of the photosensitive member and applying voltage.

Meanwhile, the photosensitive member is a multilayered organic photosensitive member formed by laminating layers having various different functions with a positive-charged organic photosensitive member (also called a positive-charged single-layer organic photosensitive member) which is a single photoconductive layer comprising charge generating material, hole transporting material, electron transporting material, and organic binders, according to this invention.

This type of positive-charged organic photosensitive member, wherein a plurality of predetermined types of functional materials are uniformly dispersed in the photoconductive layer, is coming into wide use because of its low cost and easy manufacture. Furthermore, a comparison of the single-layer type and the multilayered type reveals that the single-layer material has superior photosensitivity.

Given the state of the art as described above, in the case of electrophotographic image forming, it is preferable to employ a positive-charged single-layer organic photosensitive member, which is a single photoconductive layer, as the photosensitive member, and a contact-type charging brush or the like as the charging member; however, according to the inventors' research, it is clear that the following problems arise when employing this constitution.

Specifically, brush charging of the positive-charged single-layer organic photosensitive member results in fogging of the blank portions from the initial stage of image formation. Also, when printing continues with the device in this state, this fogging worsens.

The present invention is directed at solving such problems, and a first object thereof is to provide an image forming method wherein fogging does not occur even in the initial stage, and even in the case of the brush charging, for example, of the positive-charged organic photosensitive member, which is a single photoconductive layer.

A second object is to provide an image forming method wherein the problem of fogging does not occur even if many images are formed over a relatively long period of time.

### SUMMARY OF THE INVENTION

In order to achieve these objects, the characteristic constitution of the image forming method for electrophotographic image formation, comprises: forming images by contacting a contact charging member, to which a square AC superimposed voltage is applied, with a positive-charged organic photosensitive member which is a single photoconductive layer comprising charge generating material, hole transporting material, electron transporting material, and organic binders so as to contact charge the positive-charged organic photosensitive member.

As indicated above, in the case of an electrophotographic image forming system, it is preferable to use a positive-charged single-layer organic photosensitive member in the contact charging system; however, it has been determined that fogging may or may not occur from the initial stage (initial stage of image forming) due to the voltage pattern on the contact charging member.

Specifically, in the photosensitive member employed in this invention, fogging does not occur in the case where the AC superimposed voltage is a square wave, but fogging does occur in the case of a sine wave or the like where the voltage changes continuously. The term, “square wave” in this invention refers to a wave comprising the alternate application of a voltage change component, in which the voltage changes from the minimum voltage to the maximum voltage with a waveform that is substantially perpendicular to the time axis, and a voltage maintaining component, in which the voltage is maintained for a fixed period of time at the maximum or minimum voltage.

According to the inventors' studies, the problem of fogging does not occur with a so-called, multilayered organic photosensitive member even when the AC superimposed voltage is a sine wave. The reason why this phenomenon occurs is not clear, but the inventors assume that, when the photosensitive member employed by this invention is used, a small voltage drop (irregularity in surface potential), which cannot be measured even with a surface probe, occurs on the surface of the photosensitive member and becomes a factor in causing fogging when the AC superimposed voltage changes gradually over time.

Consequently, this object can be achieved by using a square wave as the AC superimposed voltage, so as to be able to use a specific photosensitive member such as employed in this invention and thereby prevent fogging from the initial stages of image formation.

In order to achieve the second object, it is preferable to use a photosensitive drum for image formation, which comprises an alumite layer between the positive-charged organic photosensitive member and a support for supporting the positive-charged organic photosensitive member.

In this way, when an alumite layer is provided between the photosensitive member and the support for supporting this photosensitive member (in the case of a photosensitive drum, a drum cylinder for the photosensitive drum), this layer acts as a highly resistive layer and can limit the drop in resistance (damage) to the photosensitive member even when image formation continues over a long period of time; as a result, problems of fogging occurring or worsening can be solved for continuous image formation.

An image forming device using the image forming method according to the present invention, comprises a positive-charged organic photosensitive member, which is a single photoconductive layer comprising charge generating material, hole transporting material, electron transporting material, and organic binders; a contact charging member for contacting and charging the positive-charged organic photosensitive member; and a superimposed voltage applying mechanism for applying an AC superimposed voltage to the contact charging member;

a photosensitive drum, comprising on the surface thereof a positive-charged organic photosensitive member, comprising an alumite layer at the inner surface of the positive-charged organic photosensitive member;

the contact charging member being a charging brush; and

the superimposed voltage applying mechanism applying the AC superimposed voltage to the charging brush as a square wave.

By employing this constitution, an image forming method can be provided, wherein fogging does not occur in the initial stages, even in such cases as those wherein a positive-charged organic photosensitive member, which is a single photoconductive layer, is brush charged.

Furthermore, an image forming method can be provided wherein the problem of fogging does not occur, even if many images are formed over a relatively long period of time.

### BRIEF DESCRIPTION OF THE DRAWINGS

FIG. 1 shows constituent elements in an image forming device according to the present invention.

FIG. 2 shows a sectional structural view of a photosensitive drum according to the present invention.

FIG. 3 is a descriptive table showing results of a validation experiment.

### DETAILED DESCRIPTION OF THE PREFERRED EMBODIMENTS

Embodiments of the present invention are described below with reference to the drawings.

In this description, the image forming device using the image forming method according to the present invention is described, whereafter the results of a test performed by the inventors to complete the present invention are described.

(1. Image forming device according to the present invention)

<Overview of the Image Forming Device>

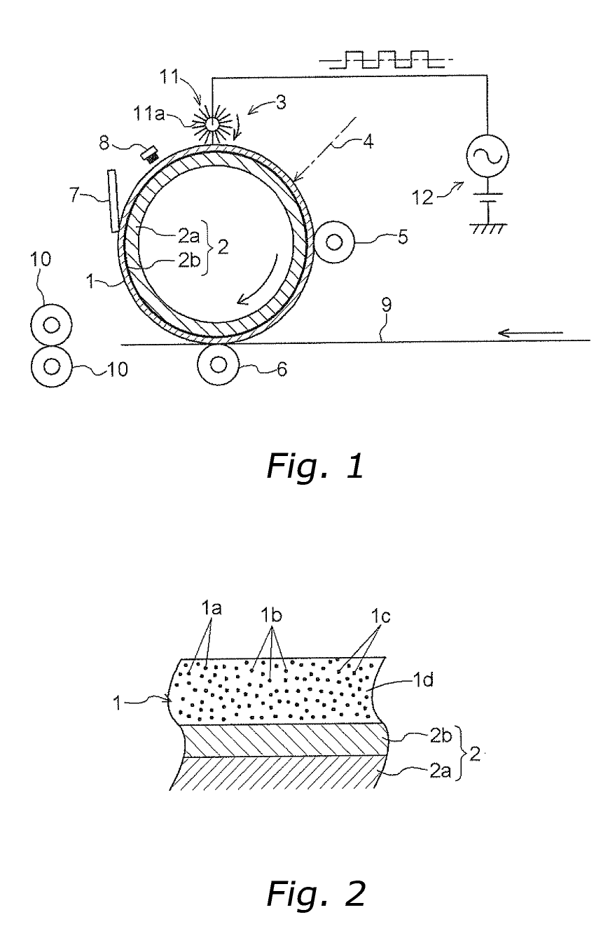

FIG. 1 shows constituent elements in an image forming device employing an electrophotographic system.

As shown in the drawing, the image forming device employing this system comprises a charging unit 3, an exposing unit 4, a developing unit 5, a transfer unit 6, a cleaning unit 7, and a charge removing unit 8, around a photosensitive drum 2 comprising a photosensitive member 1 on the surface thereof, and a fixing unit 10 is provided on the downstream side of the transport path of the transfer paper 9 from the transfer unit 6.

In image formation, the photosensitive member 1 is uniformly given a primary charge by the charging unit 3, and undergoes image exposure by irradiation based on predetermined image information, so as to form an electrostatic latent image with the exposing unit 4; this electrostatic latent image is developed in the developing unit 5, so as to form a toner image on the surface of the photosensitive member.

The toner image formed in this way on the surface of the photosensitive member is transferred to transfer paper 9 by the transfer unit 6; the transfer paper 9 with the transferred toner image is introduced to a fixing mechanism; and the toner image is fixed to the surface of the transfer paper with heat and pressure.

Meanwhile, after the transfer is complete, the toner remaining on the surface of the photosensitive member is cleaned off by the cleaning unit 7, then charge removal is performed in the charge removing unit 8 as necessary, whereby one cycle of the image forming process is completed and the process can advance to forming the next image.

The image forming device according to the present invention is based on the electrophotographic system described above, but the photosensitive member 1 is a positive-charged organic photosensitive member, which is a single photoconductive layer comprising charge generating material 1a, electron transporting material 1b, hole transporting material 1c, and organic binders 1d, as shown in FIG. 2; the image forming device further comprises a contact charging member 11 for contacting and charging this positive-charged organic photosensitive member in the charging unit 3.

Furthermore, in the photosensitive drum 2, an alumite layer 2b is provided as a highly resistive layer between the positive-charged organic photosensitive member 1 and the drum cylinder 2a; specifically, a charging brush is employed as the contact charging member 11.

As can be seen FIG. 1, the charging brush 11 is constituted as a rotating rotary brush which can rotate around a predetermined axis; in the manner of known conductive brushes, this brush is a brush comprising a bundle of conductive fibers 11a, produced by kneading conductive materials into synthetics.

A power source circuit 12 is provided, which is electrically connected to this charging brush 11; and a constitution is employed with which voltage can be applied to the charging brush 11 with alternating current superimposed on direct current. In this invention, a mechanism for applying AC voltage is called a superimposed voltage applying mechanism. This superimposed voltage applying mechanism applies AC superimposed voltage in the form of a square wave to the charging brush 11.

In this invention, as described before, the positive-charged organic photosensitive member, which is a single photoconductive layer, has certain features which are described in detail below, in relation to the photosensitive member 1.

<Positive-Charged Organic Photosensitive Member>

The positive-charged single-layer organic photosensitive member comprises a specific charge generating material (CGM) 1a, a combination of electron transporting material (ETM) 1b and hole transporting material (HTM) 1c being used as the charge transport material (CTM).

<<Charge Generating Material 1a>>

The charge generating material comprises a metal-free phthalocyanine, shown in formula (1a) as Chem. 1, or a titanium phthalocyanine shown in formula (1b) as Chem. 2, alone or blended together, so as to absorb the desired range of wavelengths.

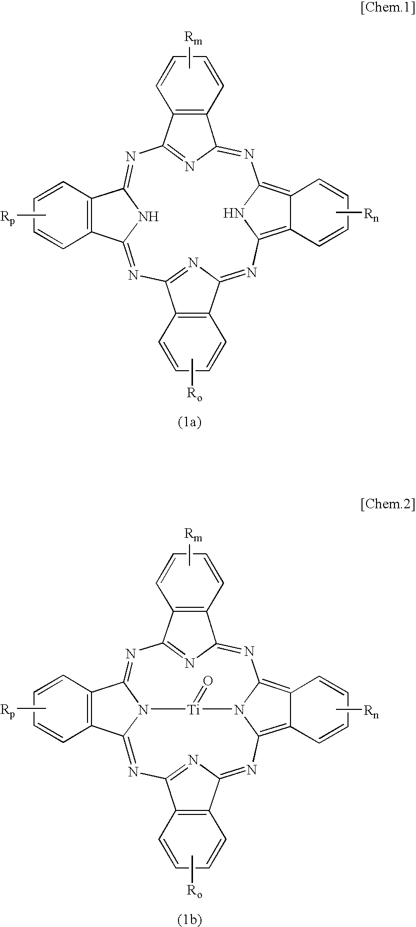

In formulas (1a) and (1b) above, the substitution group R which can bond to the aromatic rings is a halogen atom, alkyl group, aralkyl group, nitro group, or cyano group. Examples of alkyl groups for the substitution group R include C₆ or lower groups such as methyl, ethyl, propyl, butyl, or amyl, and examples of aralkyl groups include benzyl, phenylethyl, and the like.

<<Charge Transporting Material/Electron Transporting Material 1b>>

The electron transporting material 1b may be a naphthoquinone compound, as represented by formula (2a) shown as Chem. 3 or formula (2b) shown as Chem. 4, used alone or in combination.

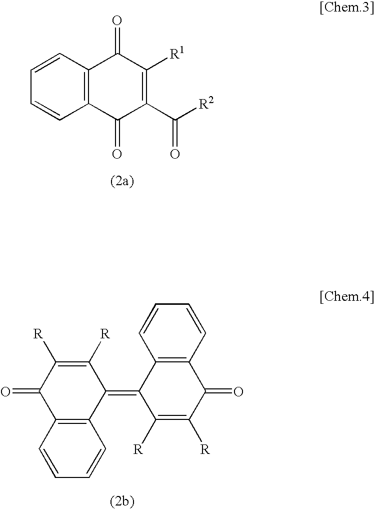

In formula (2a), R1 is an alkyl group or aryl group; R2 is an alkyl group, aryl group, or a group represented by —OR3 (where R3 is an alkyl group or aryl group).

Examples of alkyl groups for R1 to R3 include C₆ or lower groups, and in particular, for example, a methyl group, ethyl group, n-propyl group, iso-propyl group, n-butyl group, isobutyl group, sec-butyl group, tert-butyl group, pentyl group, hexyl, group, or the like. Also, some of the hydrogen atoms in these alkyl groups may be replaced with halogen atoms or the following aryl groups. The aryl group in R1 through R3 may be a phenyl group, tolyl group, xylyl group, biphenyl group, o-terphenyl group, naphthyl group, antolyl group, phenantolyl group, or the like. Some of the hydrogen atoms in these aryl groups may be replaced with halogen atoms or the aforementioned alkyl groups.

Such naphthoquinone compounds shown in formula (2a) are well known; and those wherein the R2 group is an —OR3 group are preferred; more preferably, R1 is a phenyl group or methyl group and R3 is a tert-butyl group or benzyl group.

In formula (2b), R is a hydrogen atom or alkyl group; examples of the alkyl group include C₆ or lower groups, such as a methyl group, ethyl group, n-propyl group, iso-propyl group, n-butyl group, isobutyl group, sec-butyl group, tert-butyl group, pentyl group, hexyl group or the like.

Such naphthoquinone compounds shown in formula (2b) are well known. Moreover, the naphthoquinone compound can be used together with a well known electron accepting material for the electron transporting material, so long as the relationship between the thickness of the photosensitive member and the post-exposure potential is not lost.

<<Charge Transporting Material/Hole Transporting Material 1c>>

The photosensitive member 1 according to this invention includes a naphthoquinone compound as the electron transporting material 1b, and a hole transporting material 1c may be combined therewith.

The photosensitivity can be further improved by using such a combination with the hole transporting material 1c. To achieve the relationship between the thickness of the photosensitive member and the post-exposure potential, stilbene compounds shown in formulas (3a) to (3h) as Chem. 5, 6, 7, 8, and 9, are used alone or in combinations of two or more.

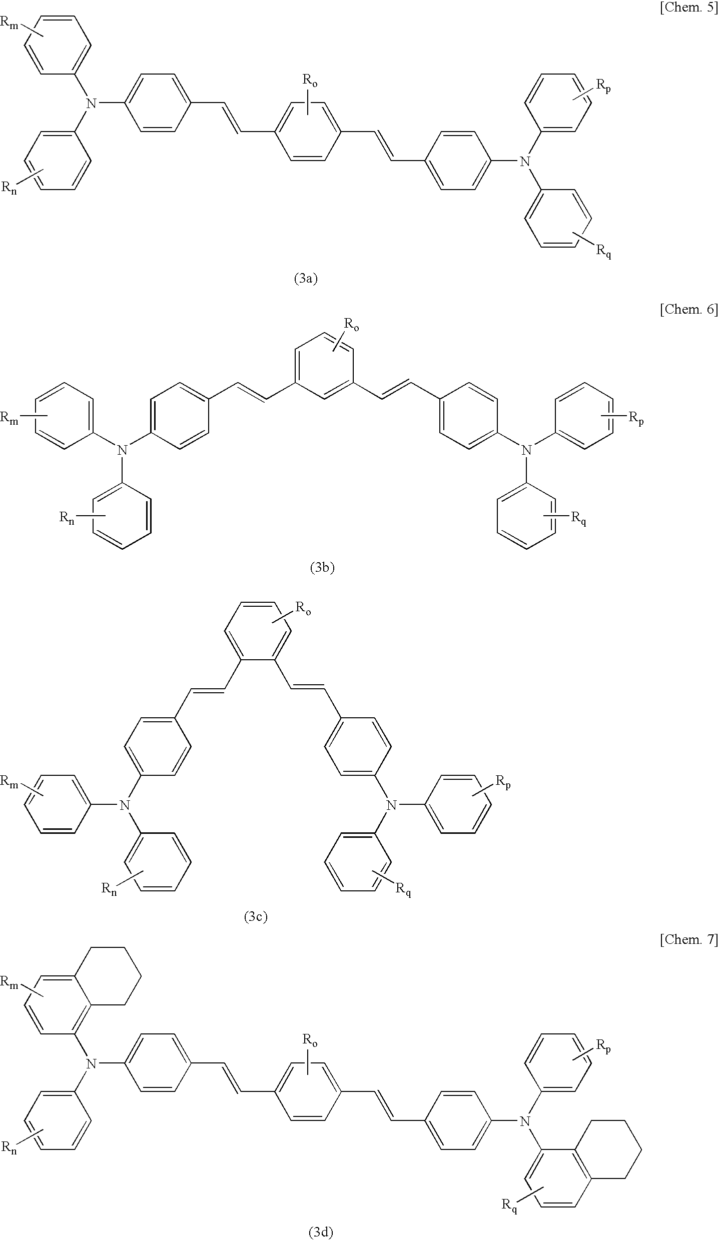

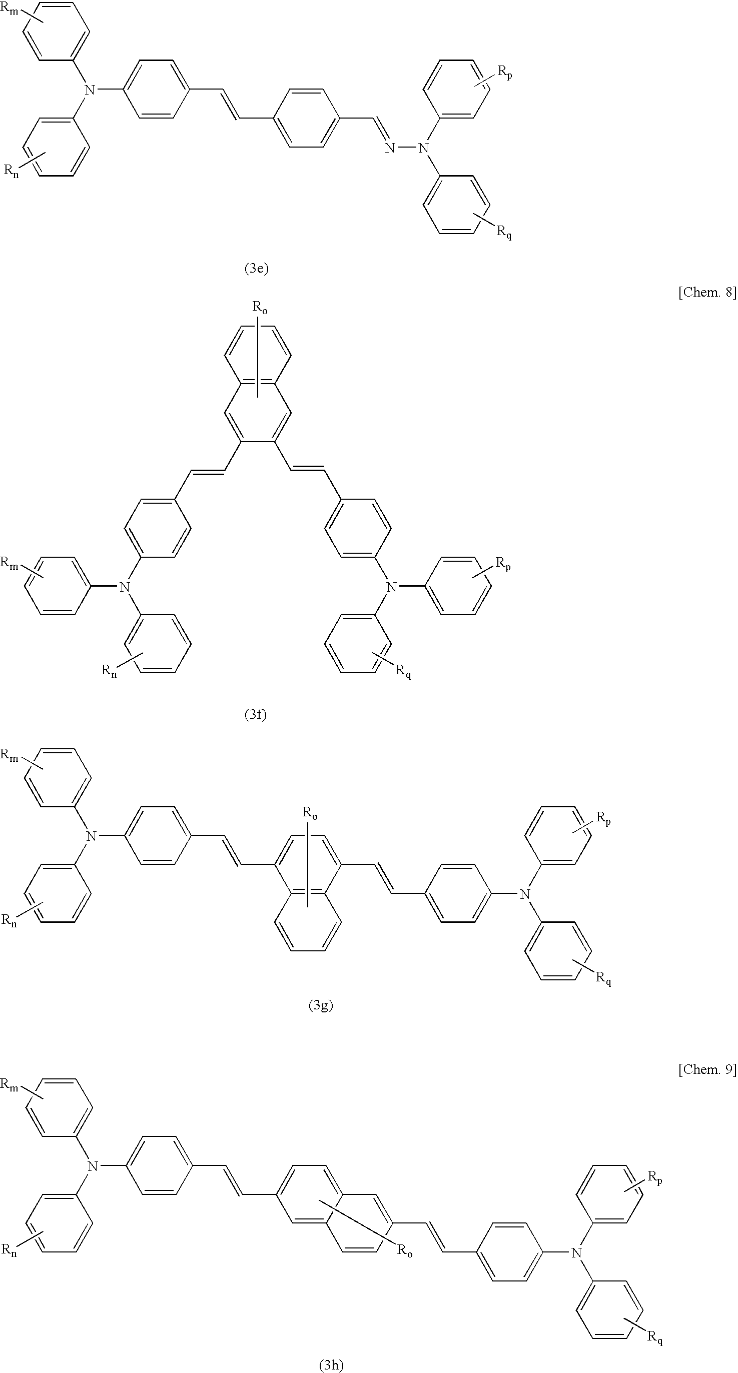

In formulas (3a) to (3h), the alkyl groups R that can bond with the benzene rings or the naphthene rings as a substitution group may be a C₆ or lower group, and particular examples include a methyl group, ethyl group, n-propyl group, iso-propyl group, n-butyl group, isobutyl group, sec-butyl group, tert-butyl group, pentyl group, hexyl group, or the like, C₄ and lower groups being preferred. Also, some of the hydrogen atoms in these alkyl groups may be replaced with halogen atoms.

<<Organic Binders 1d>>

Various resins are used as the resin medium in which the charge generating material 1a and charge transporting material are dispersed. Examples include various polymers, such as olefin polymers including styrene polymer, acrylic polymer, styrene-acrylic polymer, ethylene-vinyl acetate copolymer, polypropylene, ionomer; and photo-curing resins such as polyvinyl chloride, vinyl chloride-vinyl acetate copolymer, polyester, alkyd resin, polyamide, polyurethane, epoxy resin, polycarbonate, polyarylate, polysulfone, diarylphthalate resin, silicone resin, ketone resin, polyvinylbutyral resin, polyether resin, phenol resin, epoxyacrylate, or the like.

These resins, which are binders, can be used alone or in combinations of two or more. Preferred resins include styrene polymer, acrylic polymer, styrene-acrylic polymer, polyester resin, alkyd resin, polycarbonate, polyarylate, or the like.

<<Photosensitive Member Composition>>

The photosensitive member 1 is a single photoconductor comprising the charge generating material 1a, the electron transporting material 1b, and the hole transporting material 1c dispersed in the binder 1d.

In such a single-layer organic photosensitive member, the phthalocyanine charge generating material (CGM) 1a shown in Formula (1a) or (1b) preferably constitutes 1 to 10 wt %, and more preferably 3 to 5 wt %, per solids content by weight of the photosensitive member.

Meanwhile, the naphthoquinone electron transporting material 1b shown in Formula (2a) or (2b) preferably constitutes 3 to 100 wt %, and more preferably 50 to 80 wt %, per solids content by weight of the photosensitive member.

Furthermore, the weight ratio of naphthoquinone electron transporting material (ET) 1b to the stilbene hole transporting material (HT) 1c shown in Formulas (3a) to (3h) is preferably in the range of ET:HT=10:1 to 1:10, and particularly 1:5 to 1:1.

In such a positive-charged single-layer organic photosensitive member 1, the initial thickness of the photosensitive member is generally 10 to 100 μm, and specifically 30 to 50 μm.

<<Preparation of Photosensitive Member 1>>

Well known compounding agents such as antioxidants, radical trapping agents, singlet quenchers, UV absorbing agents, softeners, surface modifiers, defoaming agents, fillers, thickeners, dispersion stabilizers, wax, acceptors, donors, and the like, can be added to the photoconductor forming composition used for forming this photosensitive member, at quantities that do not have a negative influence on the electrophotographic properties thereof.

By adding a steric hindering phenol antioxidant in a range of 0.1 to 50 wt % per total solids content in at least the upper layer of the photosensitive member, the durability of the photosensitive member can be markedly improved without degrading the electrophotographic properties.

Various conductive materials can be used as the conductive substrate provided for the photosensitive member, for example, single metals such as aluminum, copper, tin, platinum, gold, silver, vanadium, molybdenum, chrome, cadmium, titanium, nickel, indium, stainless steel, brass, plastics with these metals laminated or evaporated thereon, glasses coated with aluminum iodide, stannic oxide, indium oxide, or the like.

In the present invention, an ordinary aluminum tube, and in particular an aluminum tube on which alumite processing has been performed so as to produce a film thickness of 1 to 50 μm, can be used.

To form the photosensitive member, a blend of the charge generating material, electron transporting material, and binding resin was formed into a coating composition using a conventional, well known method such as a roll mill, ball mill, attriter, paint shaker, ultrasonic diffuser, or the like, and the coating composition was applied using conventional, well known application means and dried.

The solvent used for forming the coating solution can be any of various organic solvents, such as alcohols, including methanol, ethanol, isopropanol, butanol, or the like; aliphatic hydrocarbons such as n-hexane, octane, cyclohexane, or the like; aromatic hydrocarbons such as benzene, toluene, xlyene, or the like; halogenated hydrocarbons such as dichloromethane, dichloroethane, carbon tetrachloride, chlorobenzene, or the like; ethers such as dimethyl ether, diethylether, tetrahydrofuran, ethylene glycol dimethylether, diethylene glycol dimethylether, or the like; ketones such as acetone, methylethylketone, cyclohexanone, or the like; esters such as ethyl acetate, methyl acetate, or the like; dimethylformamide, dimethylsulfoxide, or the like; and these may be used alone or in combinations of two or more. The solids content concentration of the coating solution may generally be 5 to 50%.

<Image Forming Process>

Image formation using the photosensitive member 1 and the principle charging, which is an item characterizing the present invention, are described by itemizing the conditions therefor.
Contact charging using a charging brush
Resistance of charging brush: 5 log Ω
Brush density: 240,000 strands/square inch
Thickness of brush-forming fibers: 2 deniers
Bite of brush tip into photosensitive member: 0.5 mm

The bite is the amount by which the tip of the brush would bite into the surface of the photosensitive member, if the photosensitive member were not present.
Brush rotation: Same direction as the rotation of the photosensitive member
Voltage applied to brush
Alternating current (AC) bias voltage: 1.2 kV
Alternating current frequency: 1 kHz
Alternating current waveform: Square
Direct current (DC) bias voltage: 400 V

When image formation was repeated under these conditions, fogging did not occur even in a test of 100×10³ pages.

Accordingly, in the image forming device according to this invention, the contact charging member 11, to which a square AC superimposed voltage is applied, is brought into contact with the positive-charged organic photosensitive member 1 which is a single photoconductive layer comprising charge generating material 1a, electron transporting material 1b, hole transporting material 1c, and organic binders 1d so that the positive-charged organic photosensitive member 1 is contact charged and an image is formed; in this case a photosensitive drum 2 is used, comprising an alumite layer 2b between the positive-charged organic photosensitive member 1 and the support 2a supporting the positive-charged organic photosensitive member.

(2. Validation test results)

The image forming device according to the present invention was described above, as well as a image forming method therefor, and the results of a validation test performed by the inventors is described below. Table 2 below shows an evaluation of the results.

A coating solution for forming the positive-charged organic photosensitive member, prepared according to common methods, was applied to 30 mm diameter aluminum tubes and dried, so as to produce positive-charged single-layer organic photosensitive members having photoconductors of various thickness. The test used aluminum tubes both with and without alumite processing of the surface. Furthermore, the photoconductive layer was 27 μm thick and the alumite layer was 6 μm thick.

In the preparation of the coating solution, a Teijin Chemicals Ltd. polycarbonate resin (TS2050/RV) was used as the organic binder 1d; a quinone compound was used as the electron acceptor; and the charge generating material, electron transporting material, and hole transporting material were combined in the following proportions and dissolved or dispersed in solvent to prepare the coating solution.

TABLE 1

| | | |
|---|---|---|
| Charge generating material | Metal-free phthalocyanine shown in 1a′ | |
| 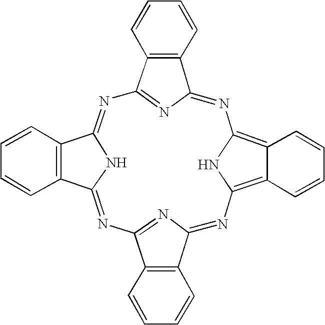 | (1 a′) | 3.2 parts by weight |
| Electron transporting material | Naphthoquinone compound shown in 2a′ | |
| 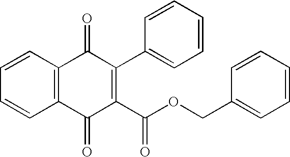 | (2 a′) | 35 parts by weight |
| Hole transporting material | Stilbene compound shown in 3a′ | |

| | | |
|---|---|---|
| 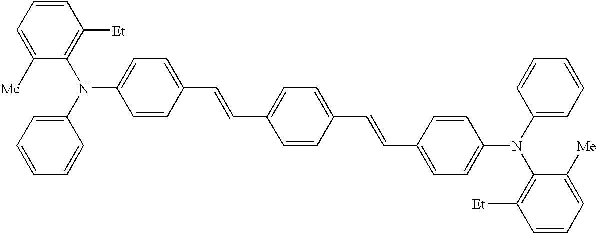 | (3 a′) | 50 parts by weight |

| | | |
|---|---|---|
| | TBDQ (tetrabutyl dibenzoquinone) | |
| Electron acceptor | shown below | |
| 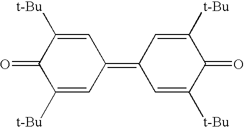 | | 5 parts by weight |
| Binding resin | TS2050/RV | 100 parts by |
| | | weight |

In this test, the same photosensitive member as the positive-charged organic photosensitive member in the image forming device according to the present invention was used, and a study was made by applying to the charging brush 11 a square wave and sine wave as the voltage waveform; moreover, photosensitive drums 2 with and without the alumite layer 2b at the interior of the photosensitive member were examined and compared.

The combinations of conditions in this test and the situations in which fogging occurred are as follows.

The frequency of the superimposed AC voltage was 1 kHz, which was the same as that of the device.

TABLE 2

| | | Alumite | | Fogging over |
|---|---|---|---|---|
| | AC waveform | layer | Initial fogging | time |
| Embodiment 1 | Square | Yes | No | No |
| Embodiment 2 | Square | No | No | Yes |
| Comparative | Sine | Yes | Yes | Worsening |
| example 1 | | | | |
| Comparative | Sine | No | Yes | Worsening |
| example 2 | | | | |

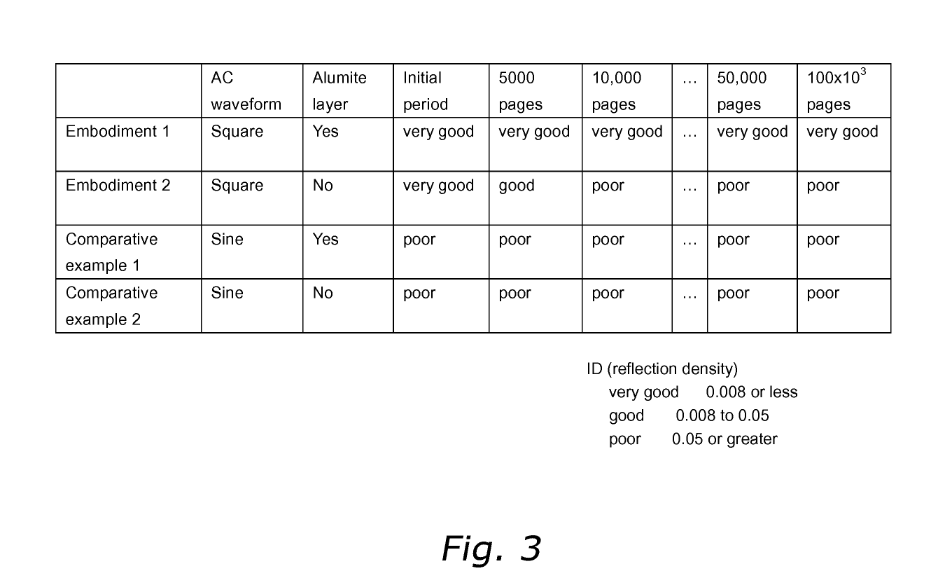

The specific number of pages which underwent image forming and the evaluation results are shown in FIG. 3.

In the first embodiment, when a square wave AC bias was applied to a drum having an alumite layer, there was no initial fogging and fogging did not occur thereafter with 100×10³ pages printed.

In the second embodiment, in the case of charging a conventional photosensitive member (no alumite layer) with a square wave AC bias, fogging did not occur initially, but slight fogging was detected after printing about 5000 pages, and fogging was not resolved thereafter.

In the first comparative example, the drum with an alumite layer was charged with a sine wave AC bias, but marked fogging occurred from the start.

An example of charging a drum without an alumite layer with a sine wave AC bias is shown as the second comparative example. Marked fogging appeared from the start.

In conclusion, initial fogging can be prevented by using a square wave AC bias; and resistance to fogging can be achieved by the provision of an alumite layer.

Based on these phenomena, the inventors believe the following with regard to fogging.

The fogging occurring in the present invention is of two types with different causes. The fogging which can be avoided with the square wave bias is thought to be caused by a lack of uniformity in surface potential; it is thought that the fogging is caused by a slight voltage drop, which cannot be detected with a surface probe, which occurs with the sine wave, and the adhesion of a small quantity of toner.

Meanwhile, the fogging which can be avoided with the alumite layer is thought to be caused by resistance dropping markedly at various locations on the photosensitive member upon proximity charging with the charging brush (the photosensitive member is damaged), and a small amount of toner adhering without surface potential. Consequently, this fogging is irreversible fogging caused by damage, unlike the initial fogging.

### Other Embodiments

The descriptions of the preceding embodiments concerned square waves with duty ratios of normally 50%; in this regard, changes to application characteristics are not possible.

In the preceding embodiments, the AC+DC bias (Vpp, Vdc) and the frequency for the square wave were Vpp 1.2 kV, Vdc 400 V, and 1 kHz; but for voltages with Vpp in the 1.0 to 1.4 kV range, Vdc can be a surface potential suited to the properties of the photosensitive member (normally in the range of 250 to 800 V) and the frequency can be in the range of 700 to 1300 kHz.

What is claimed is:

1. An image forming method for electrophotographic images formation, comprising:
forming images by contacting a contact charging member, to which a square AC superimposed voltage is applied, with a positive-charged organic photosensitive member which is a single photoconductive layer comprising charge generating material, hole transporting material, electron transporting material, and organic binders so as to contact charge the positive-charged organic photosensitive member.

2. The image forming method recited in claim 1, wherein a photosensitive drum is used for the image formation, which comprises an alumite layer between the positive-charged organic photosensitive member and a support for supporting the positive-charged organic photosensitive member.

3. An image forming device, comprising: a positive-charged organic photosensitive member which is a single photoconductive layer comprising charge generating material, hole transporting material, electron transporting material, and organic binders; a contact charging member for contacting and charging the positive-charged organic photosensitive member; and a superimposed voltage applying mechanism for applying an AC superimposed voltage to the contact charging member;
a photosensitive drum, on the surface of which the positive-charged organic photosensitive member is provided, comprising an alumite layer at the inner surface of the positive-charged organic photosensitive member;
the contact charging member being a charging brush; and
the superimposed voltage applying mechanism applying the AC superimposed voltage to the charging brush as a square wave.
